(19) United States
(12) Patent Application Publication
(10) Pub. No.: US 2024/0343648 A1
(43) Pub. Date: Oct. 17, 2024

(54) NANOPARTICLE FOR EARLY STRENGTH DEVELOPMENT OF CONCRETE, CONCRETE FORMING COMPOSITION INCLUDING THE SAME, AND METHOD FOR PRODUCING THE SAME

(71) Applicant: SILKROAD C&T CO., LTD., Seoul (KR)

(72) Inventors: Jung Sun KIM, Seoul (KR); Su II KIM, Seoul (KR); Bo Chan SEO, Suwon-si (KR); Kwang Hoon SONG, Yongin-si (KR)

(73) Assignee: SILKROAD C&T CO., LTD., Seoul (KR)

(21) Appl. No.: 18/294,803

(22) PCT Filed: Sep. 15, 2022
(86) PCT No.: PCT/KR2022/013807

§ 371 Date: Feb. 2, 2024

(30) Foreign Application Priority Data
Nov. 8, 2021 (KR) 10-2021-0152484

(51) Int. Cl. C04B 22/00; C04B 22/06; C04B 24/26; C04B 103/40

(52) U.S. Cl. CPC C04B 22/00863; C04B 22/062; C04B 24/2664; C04B 2103/408

(57) ABSTRACT

A nanoparticle suitable for early strength development of concrete and a method for producing the same are disclosed. Composition containing the nanoparticles is also disclosed. The nanoparticle can be produced by a co-precipitation process, and have different early strength enhancing effects. Thus, the nanoparticle and the composition containing the nanoparticle can be used as an early strength agent for accelerating early strength development of concrete.

### TECHNICAL FIELD

The present invention relates to a nanoparticle for early strength development of concrete and a method for producing the same, and more particularly, to a nanoparticle, which can be produced by a co-precipitation process, can have different early strength enhancing effects according to a composition, and can be used as an early strength agent for accelerating early strength development of concrete.

### BACKGROUND ART

An admixture is a material that is added in addition to cement, aggregate, and water, which are the basic materials for concrete production, to give special performance to concrete or to improve properties, and refers to a material whose amount used is less than 1% (based on solid content) with respect to cement. However, despite the relatively small amount used, the development of excellent admixtures is recognized as one of the most important factors in the development of concrete materials because the physical properties of concrete change significantly depending on the admixture used. The current mainstream of concrete admixture is AE water reducing agents, high performance water reducing agents, and high performance AE water reducing agents, and synthetic surfactants, lignin sulfonic acids, naphthalene-based admixtures, melamine-based admixtures, and polycarboxylic acid-based admixtures are used as main ingredients, but they do not guarantee the early strength or ultra-short-term strength performance of concrete.

On the other hand, it is required to use inexpensive industrial by-products, such as fly ash and blast furnace slag, which can reduce the proportion of cement and replace cement when cement concrete is produced. The amount of industrial by-products generated is increasing year by year and more than 20 million tons of industrial by-products are generated annually. Accordingly, industrial by-products are desirable as a substitute for cement. However, when industrial by-products are applied, there is a problem that the early strength of concrete is reduced. Therefore, the need for early strength additives is gradually emerging to solve this problem.

In addition, when concrete is placed in winter, the strength development of concrete is significantly delayed and the construction period is lengthened. To solve this problem, heat is applied around the placed concrete to shorten the strength development time. However, since this leads to an increase in the construction cost, it is a major issue to shorten the strength development time of concrete.

In addition, in precast concrete that is produced by pouring concrete into a mold, the early strength development of concrete is an important part. In particular, in the precast, the strength of concrete is rapidly developed by steam curing using steam. At this time, a large amount of energy is consumed. Since the precast is to produce molded concrete having a certain shape, the rotation rate of the mold used is one of the important parts. Therefore, the early strength development of concrete is an important factor in order to use less energy and increase the rotation rate of the mold.

Various materials are applied to increase the early strength of conventional cement concrete. However, since each of the materials required when producing cement concrete by applying these materials is mixed, there is a disadvantage in that it is inconvenient to use. In addition, when these materials are simply mixed, a problem such as precipitation and reaction may occur.

In this regard, Korean Patent Registration No. 10-1963579 discloses an early strength-developed concrete composition which is applicable to a part requiring early strength development.

### DESCRIPTION OF EMBODIMENTS

### Technical Problem

The present invention has been made in an effort to solve the problems of the related art, and an object of the present invention is to provide a nanoparticle capable of accelerating early strength development of hydraulic materials, particularly concrete, and a concrete forming composition including the same.

In addition, an object of the present invention is to provide a method for producing a nanoparticle for early strength development of concrete, which can have different early strength enhancing effects according to a composition.

### Solution to Problem

To achieve the objects described above, an aspect of the present invention is to provide a nanoparticle for early strength development of concrete, the nanoparticle including calcium silicate hydrate, wherein a molar ratio (Ca/Si) of calcium to silicon of the calcium silicate hydrate is 2 to 10.

A size of the nanoparticle may be 10 nm to 1,000 nm.

Another aspect of the present invention is to provide a concrete forming composition including aggregate, a binder, an admixture, and water, wherein the admixture includes the nanoparticle for early strength development of concrete.

The binder may include at least one selected from the group consisting of ordinary Portland cement, early strength Portland cement, lime cement, slag cement, blast furnace slag cement, slag powder, Portland pozzolan cement, fly ash, bottom ash, gypsum cement, lime cement, silica fume, low heat cement, and desulfurization gypsum.

Another aspect of the present invention is to provide a method for producing a nanoparticle for early strength development of concrete, the method including: preparing a mixture by mixing a first solution containing a water-soluble calcium compound and a second solution containing a water-soluble silicate compound; and stirring the mixture to produce a nanoparticle, wherein the nanoparticle includes calcium silicate hydrate, and a molar ratio (Ca/Si) of calcium to silicon of the calcium silicate hydrate is 2 to 10.

The water-soluble calcium compound may include at least one selected from the group consisting of calcium nitrate, calcium chloride, calcium formate, calcium acetate, calcium bicarbonate, calcium bromide, calcium carbonate, calcium citrate, calcium chlolate, calcium fluoride, calcium gluconate, calcium hydroxide, calcium oxide, calcium hypochlorite, calcium iodate, calcium iodide, calcium lactate, calcium nitrite, calcium oxalate, calcium phosphate, calcium propionate, calcium silicate, calcium stearate, calcium sulfate, calcium sulfate hemihydrate, calcium sulfate dihydrate, calcium sulfide, calcium tartrate, calcium aluminate, tricalcium silicate, dicalcium silicate, and any hydrate thereof.

The water-soluble silicate compound may include at least one selected from the group consisting of sodium silicate, potassium silicate, waterglass, aluminum silicate, tricalcium silicate, dicalcium silicate, calcium silicate, silicic acid, sodium metasilicate, potassium metasilicate, and any hydrate thereof.

The nanoparticle may be produced by a co-precipitation process.

The mixture may further include at least one selected from the group consisting of a dispersant, an alkali metal hydroxide, and any combination thereof.

The dispersant may include a polycarboxylate-based compound.

The alkali metal hydroxide may include at least one selected from the group consisting of sodium hydroxide (NaOH), potassium hydroxide (KOH), and lithium hydroxide (LiOH).

The method may further include, after the step of producing the nanoparticle, drying the nanoparticle.

### ADVANTAGEOUS EFFECTS OF DISCLOSURE

A nanoparticle according to the present invention can accelerate early strength development of hydraulic materials, especially concrete, and thus can be used as an early strength development accelerator, and has an effect of shortening the construction period and reducing the construction cost and labor cost.

In addition, the nanoparticle for early strength development of concrete according to the present invention has an effect that an early strength enhancing effect may vary depending on a molar ratio (Ca/Si) of calcium to silicon.

### BRIEF DESCRIPTION OF DRAWINGS

FIG. 1 is a flowchart of a method for producing a nanoparticle for early strength development of concrete according to the present invention.

FIG. 2 is a graph showing the compressive strength of concrete forming compositions produced according to Examples 1 to 10 and Comparative Examples 1 to 4.

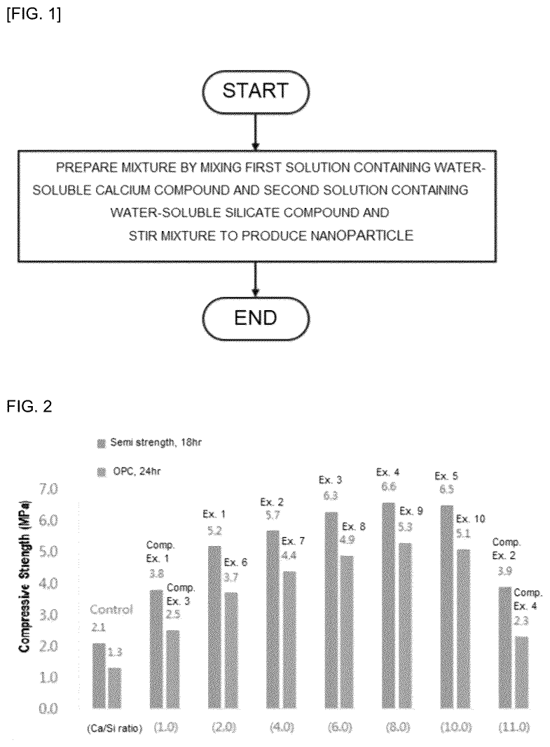

### MODE OF DISCLOSURE

Hereinafter, the present invention will be described in more detail. However, the present invention may be embodied in various different forms and is not limited by embodiments described herein, and the present invention is only defined by the claims to be described below.

In addition, the terms as used herein are only used to describe specific embodiments, and are not intended to limit the present invention. The singular forms “a,” “an,” and “the” as used herein are intended to include the plural forms as well unless the context clearly indicates otherwise. In the specification of the present invention, the phrase “including a certain element” means “further including other elements” rather than excluding other elements unless otherwise stated.

A first aspect of the present application is to provide a nanoparticle for early strength development of concrete, which includes calcium silicate hydrate.

Hereinafter, the nanoparticle for early strength development of concrete according to the first aspect of the present application will be described in detail.

According to an embodiment of the present application, the nanoparticle may include calcium silicate hydrate.

In general, in a cement hydration process, a cement compound reacts with water to form a hydrate and is set while losing fluidity. As more time passes, a hydration process further proceeds. The strength of the structure is increased through a hardening process. Accordingly, hydration and hardening (strength) form a close relationship. The hydrate includes tricalcium silicate (3CaOSiO₂) called alite (C₃S) and dicalcium silicate (2CaOSiO₂) commonly called belite (C₂S). C₃S accounts for the largest proportion of the cement compound. C₂S reacts with water to directly produce calcium hydroxide [Ca(OH)₂] and calcium silicate hydrate (C—S—H, hereinafter abbreviated as “CSH”). At this time, it is known that the initial production rate of CSH, which is the final hydration product of the cement compound, has a great influence on whether the early strength of concrete is secured, and this is known as the rate determining step of the hydration process, which usually takes as little as 6 hours and as much as 10 hours.

Therefore, when the nanoparticle according to the present invention, which includes calcium silicate hydrate (C—S—H), is mixed with the concrete mixture, the nanoparticle acts as a nucleation seed. As the nanoparticle grows larger, the nanoparticle fills a void between cement particles, and thus, it is possible to omit the initial cement hydration process, which is the existing rate determining step. Therefore, the curing time of concrete can be drastically reduced. Due to this addition, the construction period of the construction site can be shortened to ⅔ compared to the existing construction period through the realization of early strength development that is impossible in the existing concrete and the development of applied technology. Accordingly, there is an advantage that can increase process efficiency and can dramatically reduce energy. In addition, there is an effect of reducing the construction cost and labor cost.

According to an embodiment of the present application, a molar ratio (Ca/Si) of calcium to silicon of the calcium silicate hydrate may be 2 to 10. That is, the molar ratio of calcium (Ca) to silicon (Si) may be 1:2 to 10. When the molar ratio (Ca/Si) of calcium to silicon of the calcium silicate hydrate is out of the above range, that is, when the molar ratio (Ca/Si) of calcium to silicon is less than 2 or greater than 10, the early strength enhancing effect may be insignificant. Therefore, compared with a case where the ratio (Ca/Si) of calcium to silicon is within the above range, the compressive strength is significantly low, which is not preferable.

According to an embodiment of the present application, the size of the nanoparticle for early strength development of concrete may be 10-1,000 nm.

A second aspect of the present application provides a concrete forming composition including aggregate, a binder, an admixture, and water.

Hereinafter, the concrete forming composition according to the second aspect of the present application will be described in detail.

According to an embodiment of the present application, the concrete forming composition may include aggregate.

The aggregate is the base of the concrete forming composition and is a mineral material for construction that can be agglomerated by the binder to form a single mass.

According to an embodiment of the present application, the aggregate included in the concrete forming composition may include fine aggregate and coarse aggregate. In the present specification, the fine aggregate refers to an aggregate of a particle size that passes 100% through a 5-mm standard mesh. In the present specification, the coarse aggregate refers to an aggregate of a particle size that remains 100% in a 5-mm standard mesh.

According to an embodiment of the present application, the fine aggregate may include crushed sand, natural sand, washed sand, recycled aggregate having a particle size of 0.01-5 mm, or any combination thereof. According to an embodiment of the present application, the fine aggregate may preferably be crushed sand, but is not limited thereto.

According to an embodiment of the present application, the coarse aggregate may include crushed stone, crushed slag, natural gravel, crushed gravel, recycled aggregate having a particle size of 5-25 mm, or any combination thereof. According to an embodiment of the present application, the coarse aggregate may be crushed gravel, but is not limited thereto.

According to an embodiment of the present application, the amount of the aggregate may be 60-90 parts by weight based on 100 parts by weight of the total amount of the concrete forming composition. When the amount of the aggregate is less than 60 parts by weight based on 100 parts by weight of the total amount of the concrete forming composition, in the case of producing concrete from the concrete forming composition, the compressive strength of concrete increases, but the production cost of concrete increases. When the amount of the aggregate is greater than 90 parts by weight based on 100 parts by weight of the total amount of the concrete forming composition, separation between the aggregate and the binder may occur and the quality of concrete may deteriorate.

According to an embodiment of the present application, the fine aggregate ratio (S/A) of the concrete forming composition may be 35-65%. The fine aggregate ratio (S/A) refers to the percentage of the absolute volume of the fine aggregate(S) with respect to the total aggregate (A) (fine aggregate+coarse aggregate). When the fine aggregate ratio (S/A) of the concrete forming composition is less than 35%, the unit quantity and unit cement quantity decrease, resulting in a decrease in workability. In addition, there is a problem in that it becomes rough concrete and may show a phenomenon of separation from other materials. When the fine aggregate ratio (S/A) of the concrete forming composition is greater than 65%, there is a problem in that drying shrinkage, settlement cracks, and plastic shrinkage cracks increase.

According to an embodiment of the present application, the concrete forming composition may include a binder.

The binder serves to impart durability and strength to concrete by improving and maintaining adhesion between the aggregates (for example, the fine aggregate or the coarse aggregate) included in the concrete forming composition.

According to an embodiment of the present application, the binder may include ordinary Portland cement, early strength Portland cement, lime cement, slag cement, blast furnace slag cement, Portland pozzolan cement, fly ash, bottom ash, gypsum cement, silica fume, low heat cement, or any combination thereof.

According to an embodiment of the present application, the binder may include ordinary Portland cement, early strength Portland cement, or any combination thereof, but is not limited thereto.

According to an embodiment of the present application, the amount of the binder may be 1-50 parts by weight based on 100 parts by weight of the total amount of the concrete forming composition. When the amount of the binder is within the above range with respect to 100 parts by weight of the total amount of the concrete forming composition, the production cost of concrete can be reduced and watertightness can be improved.

According to an embodiment of the present application, the water-to-binder ratio (W/B) of the concrete forming composition may be 20-60%. According to an embodiment of the present application, the water-to-binder ratio (W/B) of the concrete forming composition may be 40-50%. The water-to-binder ratio (W/B) refers to the percentage of the amount of water (W) with respect to the binder (B). When the water-to-binder ratio (W/B) of the concrete forming composition is less than 20%, the fluidity of the concrete produced from the concrete forming composition may be reduced. When the water-to-binder ratio (W/B) of the concrete forming composition is greater than 60%, the durability and strength of the concrete produced from the concrete forming composition may be reduced.

According to an embodiment of the present application, the concrete forming composition may include an admixture.

According to an embodiment of the present application, the admixture may include the nanoparticle for early strength development of concrete according to the first aspect of the present application.

According to an embodiment of the present application, the nanoparticle may include calcium silicate hydrate.

According to an embodiment of the present application, the nanoparticle may be provided as an admixture for accelerating early strength development of concrete.

When the nanoparticle including the calcium silicate hydrate is used as the admixture, the nanoparticle acts as a nucleation seed. As the nanoparticle grows larger, the nanoparticle fills a void between cement particles, and thus, it is possible to omit the initial cement hydration process, which is the existing rate determining step. Therefore, the curing time of concrete can be drastically reduced. Due to this addition, the construction period of the construction site can be shortened to ⅔ compared to the existing construction period through the realization of early strength development that is impossible in the existing concrete and the development of applied technology. Accordingly, there is an advantage that can increase process efficiency, can dramatically reduce energy, and can reduce the construction cost and labor cost.

According to an embodiment of the present application, a molar ratio (Ca/Si) of calcium (Ca) to silicon (Si) of the calcium silicate hydrate may be 2 to 10. That is, the molar ratio (Ca/Si) of calcium (Ca) to silicon (Si) of the calcium silicate hydrate may be 1:2 to 10. When the molar ratio (Ca/Si) of calcium to silicon of the calcium silicate hydrate is out of the above range, that is, when the molar ratio (Ca/Si) of calcium to silicon is less than 2 or greater than 10, the early strength enhancing effect may be insignificant. Therefore, compared with a case where the ratio (Ca/Si) of calcium to silicon is within the above range, the compressive strength is significantly low, which is not preferable.

According to an embodiment of the present application, the size of the nanoparticle for early strength development of concrete may be 10-1,000 nm.

According to an embodiment of the present application, the concrete forming composition may include water.

Any water may be used as long as the water does not contain harmful substances, for example, oil, acid, alkali, salt, and organic matter. The type of usable water is not particularly limited, and underground water, tap water, and the like may be used.

A third aspect of the present application provides a method for producing a nanoparticle for early strength development of concrete, the method including preparing a mixture by mixing a first solution containing a water-soluble calcium compound and a second solution containing a water-soluble silicate compound, and stirring the mixture to produce a nanoparticle.

Hereinafter, the method for producing a nanoparticle for early strength development of concrete according to the third aspect of the present application will be described in detail.

According to an embodiment of the present application, the method for producing a nanoparticle may include preparing a mixture by mixing a first solution containing a water-soluble calcium compound and a second solution containing a water-soluble silicate compound, and stirring the mixture to produce a nanoparticle.

According to an embodiment of the present application, the water-soluble calcium compound may include at least one selected from the group consisting of calcium nitrate, calcium chloride, calcium formate, calcium acetate, calcium bicarbonate, calcium bromide, calcium carbonate, calcium citrate, calcium chlolate, calcium fluoride, calcium gluconate, calcium hydroxide, calcium oxide, calcium hypochlorite, calcium iodate, calcium iodide, calcium lactate, calcium nitrite, calcium oxalate, calcium phosphate, calcium propionate, calcium silicate, calcium stearate, calcium sulfate, calcium sulfate hemihydrate, calcium sulfate dihydrate, calcium sulfide, calcium tartrate, calcium aluminate, tricalcium silicate, dicalcium silicate, and hydrates thereof.

According to an embodiment of the present application, the water-soluble calcium compound may include calcium nitrate hydrate, and preferably calcium nitrate tetrahydrate (Ca(NO₃)₂ 4H₂O).

According to an embodiment of the present application, the water-soluble silicate compound may include at least one selected from the group consisting of sodium silicate, potassium silicate, waterglass, aluminum silicate, tricalcium silicate, dicalcium silicate, calcium silicate, silicic acid, sodium metasilicate, potassium metasilicate, and any hydrate thereof.

According to an embodiment of the present application, the water-soluble silicate compound may include sodium metasilicate hydrate, and preferably sodium metasilicate pentahydrate (Na₂SiO₃·5H₂O).

According to an embodiment of the present application, the molar ratio (Ca/Si) of the calcium (Ca) component of the water-soluble calcium compound of the first solution to the silicon (Si) component of the water-soluble silicate compound of the second solution may be 2 to 10. When the molar ratio (Ca/Si) of the calcium component to the silicon component is out of the above range, that is, when the molar ratio (Ca/Si) of the calcium component to the silicon component is less than 2 or greater than 10, the early strength enhancing effect may be insignificant. Therefore, compared with a case where the ratio (Ca/Si) of the calcium component to the silicon component is within the above range, the compressive strength is significantly low, which is not preferable.

According to an embodiment of the present application, the early strength enhancing effect of the nanoparticle for early strength development of concrete may be different according to the molar ratio (Ca/Si) of the calcium component to the silicon component.

According to an embodiment of the present application, the nanoparticle may be produced by a co-precipitation process. The co-precipitation process refers to a process of simultaneously precipitating several different ions in an aqueous or non-aqueous solution. Specifically, the co-precipitation process is a process which, when preparing a compound containing target ions, can prepare a compound, in which other ions are doped in a part of crystal sites of target ions, by precipitating other ions together with the target ions when precipitating the target ions in a solution. That is, the nanoparticle may be produced by co-precipitation of calcium and silicate ions.

According to an embodiment of the present application, the mixture may further include at least one selected from the group consisting of a dispersant, an alkali metal hydroxide, and any combination thereof.

According to an embodiment of the present application, the dispersant may include a polymer dispersant.

According to an embodiment of the present application, the polymer dispersant may include a polycarboxylate-based compound.

The dispersant may inhibit aggregation between particles of the water-soluble calcium compound, the water-soluble silicate compound, the alkali metal hydroxide, and the like used in the method for producing a nanoparticle according to the present invention, and may space the particles apart from each other by using an electrostatic or physical repulsive force. Accordingly, uniform strength can be developed in the entire area of cement concrete, and sufficient workability can be secured while reducing the amount of water mixed.

According to an embodiment of the present application, the first solution containing the water-soluble calcium compound may further include the dispersant, and may the mixture may be prepared by mixing the first solution containing the water-soluble calcium compound and the dispersant with the second solution.

According to an embodiment of the present application, after adding distilled water and a polycarboxylate-based compound as a dispersant in a reactor, the first solution containing the water-soluble calcium compound and the second solution containing the water-soluble silicate compound may be simultaneously added to the reactor containing the dispersant and the distilled water and then stirred.

According to an embodiment of the present application, the stirring may be mechanical stirring, but is not limited thereto.

According to an embodiment of the present application, the alkali metal hydroxide may include at least one selected from the group consisting of sodium hydroxide (NaOH), potassium hydroxide (KOH), and lithium hydroxide (LiOH).

According to an embodiment of the present application, the alkali metal hydroxide may include sodium hydroxide (NaOH).

According to an embodiment of the present application, the method for producing a nanoparticle may further include, after the step of producing the nanoparticle, drying the nanoparticle. As the drying step, one of the conventional drying methods may be used. Methods such as natural drying, hot air drying, and freeze drying may be used, but the present invention is not limited thereto.

In the method for producing a nanoparticle for early strength development of concrete according to the third aspect of the present application, the early strength enhancing effect of the produced nanoparticle is controlled by adjusting the molar ratio (Ca/Si) of the calcium component of the water-soluble calcium compound to the silicon component of the water-soluble silicate compound. When the molar ratio (Ca/Si) of calcium to silicon is 2 to 10, the early strength enhancing effect of the nanoparticle including the calcium silicate hydrate is excellent, and thus, the compressive strength is remarkably high. In addition, the method for producing a nanoparticle is simple in process and has only to adjust the molar ratio (Ca/Si) of calcium to silicon in order to obtain the nanoparticle having an excellent early strength enhancing effect, thereby obtaining an effect that the time and energy required to obtain the desired nanoparticle are small and productivity is excellent. The nanoparticle produced according to the method for producing a nanoparticle for early strength development of concrete has an effect of accelerating early strength development of concrete, and thus can be used as an admixture for early strength development of concrete, that is, an early strength agent.

Hereinafter, examples of the present invention will be described so that those of ordinary skill in the art may easily carry out the present invention. However, the present invention may be implemented in various different forms and is not limited to the examples described herein.

### EXAMPLES

### Production Examples 1 to 5: Production of Nanoparticle for Early Strength Development of Concrete

### Production Example 1

101.9 g of calcium nitrate tetrahydrate ((CaNO₃)₂·4H₂O, Mw: 236 g/mol) and 43.7 g of distilled water were measured into a 500-ml beaker, were stirred for 30 minutes using a magnetic stirrer, and were thus completely dissolved to prepare a first solution.

45.7 g of soda metasilicate pentahydrate (Na₂SiO₃·5H₂O, Mw: 212 g/mol) and 473.7 g of distilled water were measured into a 1,000-ml beaker and were stirred for 30 minutes using a magnetic stirrer to prepare a second solution.

After 100 g of a polycarboxylate-based dispersant (available from Silk Road CNT) as a dispersant and 235 g of distilled water were measured and added into a 2L four-neck flask reactor, a nanoparticle was produced by stirring the first solution and the second solution for 120 minutes at 500 rpm using a mechanical stirrer while simultaneously adding the first solution and the second solution to the reactor containing the dispersant and the distilled water. At this time, the molar ratio (Ca/Si) of the Ca component of the first solution to the Si component of the second solution was 2.0.

### Production Example 2

A nanoparticle was produced in the same manner as in Production Example 1, except that a first solution and a second solution were prepared so that the molar ratio (Ca/Si) of the Ca component of the first solution to the Si component of the second solution in Production Example 1 was 4.0 instead of 2.0.

### Production Example 3

A nanoparticle was produced in the same manner as in Production Example 1, except that a first solution and a second solution were prepared so that the molar ratio (Ca/Si) of the Ca component of the first solution to the Si component of the second solution in Preparation Example 1 was 6.0 instead of 2.0.

### Production Example 4

A nanoparticle was produced in the same manner as in Production Example 1, except that a first solution and a second solution were prepared so that the molar ratio (Ca/Si) of the Ca component of the first solution to the Si component of the second solution in Preparation Example 1 was 8.0 instead of 2.0.

### Production Example 5

A nanoparticle was produced in the same manner as in Production Example 1, except that a first solution and a second solution were prepared so that the molar ratio (Ca/Si) of the Ca component of the first solution to the Si component of the second solution in Production Example 1 was 10.0 instead of 2.0.

### Comparative Production Example 1

A nanoparticle was produced in the same manner as in Production Example 1, except that a first solution and a second solution were prepared so that the molar ratio (Ca/Si) of the Ca component of the first solution to the Si component of the second solution in Production Example 1 was 1.0 instead of 2.0.

### Comparative Production Example 2

A nanoparticle was produced in the same manner as in Production Example 1, except that a first solution and a second solution were prepared so that the molar ratio (Ca/Si) of the Ca component of the first solution to the Si component of the second solution in Production Example 1 was 11.0 instead of 2.0.

The amounts of (CaNO₃)₂·4H₂O, Na₂SiO₃·5H₂O, the polycarboxylate-based dispersant, the distilled water, and the molar ratio (Ca/Si) of calcium to silicon, which were used in Production Examples 1 to 5 and Comparative Production Examples 1 and 2, are shown in Table 1 below.

TABLE 1

| | First solution | | | Second solution | | Reactor | | Ca/Si |
|---|---|---|---|---|---|---|---|---|
| | | | Distilled | | Distilled | Polycarboxylate- | Distilled | molar |
| Classification | (CaNO₃)₂•4H₂O | | water | Na₂SiO₃•5H₂O | water | based dispersant | water | ratio |
| Production | 101.9 | g | 43.7 g | 45.7 g | 473.7 g | 100 g | 235 g | 2.0 |
| Example 1 | | | | | | | | |
| Production | 117.6 | g | 50.4 g | 26.4 g | 470.6 g | 100 g | 235 g | 4.0 |
| Example 2 | | | | | | | | |
| Production | 124.1 | g | 53.2 g | 18.6 g | 469.2 g | 100 g | 235 g | 6.0 |
| Example 3 | | | | | | | | |
| Production | 127.6 | g | 54.7 g | 14.3 g | 468.4 g | 100 g | 235 g | 8.0 |
| Example 4 | | | | | | | | |
| Production | 129.8 | g | 55.6 g | 11.7 g | 468.0 g | 100 g | 235 g | 10.0 |
| Example 5 | | | | | | | | |
| Comparative | 79.9 | g | 34.3 g | 71.8 g | 479.0 g | 100 g | 235 g | 1.0 |
| Production | | | | | | | | |
| Example 1 | | | | | | | | |
| Comparative | 130.6 | g | 56.0 g | 10.7 g | 467.8 g | 100 g | 235 g | 11.0 |
| Production | | | | | | | | |
| Example 2 | | | | | | | | |

### Examples 1 to 5: Concrete Forming Composition (Including Semi-Strength Cement)

### Example 1

A concrete forming composition including the nanoparticle produced according to Production Example 1 was produced with the composition shown in Table 2 below.

### Example 2

A concrete forming composition including the nanoparticle produced according to Production Example 2 was produced with the composition shown in Table 2 below.

### Example 3

A concrete forming composition including the nanoparticle produced according to Production Example 3 was produced with the composition shown in Table 2 below.

### Example 4

A concrete forming composition including the nanoparticle produced according to Production Example 4 was produced with the composition shown in Table 2 below.

### Example 5

A concrete forming composition including the nanoparticle produced according to Production Example 5 was produced with the composition shown in Table 2 below.

### Comparative Example 1

A concrete forming composition including the nanoparticle produced according to Comparative Production Example 1 was produced with the composition shown in Table 2 below.

### Comparative Example 2

A concrete forming composition including the nanoparticle produced according to Comparative Production Example 2 was produced with the composition shown in Table 2 below.

TABLE 2

| | Nanoparticle | W/B | S/A | Unit weight (kg/m³) | | | | Ad | Sample |
|---|---|---|---|---|---|---|---|---|---|
| Classification | used | (%) | (%) | Water | Cement | Sand | Gravel | (%) | (%) |
| Example 1 | Production | 48.5 | 51 | 165 | 340 | 908 | 892 | 0.3 | 1.3 |
| | Example 1 | | | | | | | | |
| Example 2 | Production | | | | | | | | |
| | Example 2 | | | | | | | | |
| Example 3 | Production | | | | | | | | |
| | Example 3 | | | | | | | | |
| Example 4 | Production | | | | | | | | |
| | Example 4 | | | | | | | | |
| Example 5 | Production | | | | | | | | |
| | Example 5 | | | | | | | | |
| Comparative | Comparative | | | | | | | | |
| Example 1 | Production | | | | | | | | |
| | Example 1 | | | | | | | | |
| Comparative | Comparative | | | | | | | | |
| Example 2 | Production | | | | | | | | |
| | Example 2 | | | | | | | | |

W/B: Water/Binder
S/A: Percentage of absolute volume of fine aggregate (S) with respect to total aggregate (A) (fine aggregate + coarse aggregate)
Cement: Semi-strength cement (Asia Cement Co., Ltd.)
Sand: Crushed sand
Gravel: Coarse aggregate with diameter of 25 mm
Ad: Polycarboxylate-based dispersant (20%) solution
Sample: Nanoparticles produced according to Production Examples 1 to 5 and Comparative Production Examples 1 and 2

### Examples 6 to 10: Concrete Forming Composition (Including OPC Cement)

### Example 6

A concrete forming composition including the nanoparticle produced according to Production Example 1 was produced with the composition shown in Table 3 below.

### Example 7

A concrete forming composition including the nanoparticle produced according to Production Example 2 was produced with the composition shown in Table 3 below.

### Example 8

A concrete forming composition including the nanoparticle produced according to Production Example 3 was produced with the composition shown in Table 3 below.

### Example 9

A concrete forming composition including the nanoparticle produced according to Production Example 4 was produced with the composition shown in Table 3 below.

### Example 10

A concrete forming composition including the nanoparticle produced according to Production Example 5 was produced with the composition shown in Table 3 below.

### Comparative Example 3

A concrete forming composition including the nanoparticle produced according to Comparative Production Example 1 was produced with the composition shown in Table 3 below.

### Comparative Example 4

A concrete forming composition including the nanoparticle produced according to Comparative Production Example 2 was produced with the composition shown in Table 3 below.

TABLE 3

| | Nanoparticle | W/B | S/A | Unit weight (kg/m³) | | | | Ad | Sample |
|---|---|---|---|---|---|---|---|---|---|
| Classification | used | (%) | (%) | Water | Cement | Sand | Gravel | (%) | (%) |
| Example 6 | Production | 48.5 | 51 | 165 | 340 | 908 | 892 | 0.3 | 1.3 |
| | Example 1 | | | | | | | | |
| Example 7 | Production | | | | | | | | |
| | Example 2 | | | | | | | | |
| Example 8 | Production | | | | | | | | |
| | Example 3 | | | | | | | | |
| Example 9 | Production | | | | | | | | |
| | Example 4 | | | | | | | | |
| Example 10 | Production | | | | | | | | |
| | Example 5 | | | | | | | | |
| Comparative | Comparative | | | | | | | | |
| Example 3 | Production | | | | | | | | |
| | Example 1 | | | | | | | | |
| Comparative | Comparative | | | | | | | | |
| Example 4 | Production | | | | | | | | |
| | Example 2 | | | | | | | | |

W/B: Water/Binder
S/A: Percentage of absolute volume of fine aggregate with respect to total aggregate (A) (fine aggregate + coarse aggregate)
Cement: OPC (Ssangyong)
Sand: Crushed sand
Gravel: Coarse aggregate with diameter of 25 mm
Ad: Polycarboxylate-based dispersant (20%) solution
Sample: Nanoparticles produced according to Production Examples 1 to 5 and Comparative Production Examples 1 and 2

### EXPERIMENTAL EXAMPLES

### Experimental Example 1: Concrete Performance Evaluation

In order to evaluate the concrete early strength performance of the concrete forming compositions produced according to Examples 1 to 10 and Comparative Examples 1 to 4, the compressive strength for each curing temperature and curing time was measured. The compressive strength was compared by producing a concrete forming composition of Control Example with the composition shown in Table 4 below.

TABLE 4

| | | | | | | | | Sam- |
|---|---|---|---|---|---|---|---|---|
| Classifi- | W/B | S/A | Unit weight (kg/m³) | | | | Ad | ple |
| cation | (%) | (%) | Water | Cement | Sand | Gravel | (%) | (%) |
| Control | 48.5 | 51 | 165 | 340 | 908 | 892 | 1.1 | — |

In Table 4, Cement is semi-strength cement available from Asia Cement or OPC cement available from Ssangyong.

The curing temperature and curing time of Examples 1 to 5 and Comparative Examples 1 and 2 using the semi-strength cement available from Asia Cement were 13° C. and 18 hours, respectively, and the compressive strength of the concrete forming compositions produced according to Examples 1 to 5 and Comparative Examples 1 and 2 are shown in Table 5 and FIG. 2 below.

TABLE 5

| | | Compressive strength |
|---|---|---|
| Classification | Ca/Si molar ratio | (MPa) |
| Control | — | 2.1 |
| Comparative Example 1 | 1.0 | 3.8 |
| Example 1 | 2.0 | 5.2 |
| Example 2 | 4.0 | 5.7 |
| Example 3 | 6.0 | 6.3 |
| Example 4 | 8.0 | 6.6 |
| Example 5 | 10.0 | 6.5 |
| Comparative Example 2 | 11.0 | 3.9 |

The curing temperature and curing time of Examples 6 to 10 and Comparative Examples 3 and 4 using OPC available from Ssangyong were 15° C. and 24 hours, respectively, and the compressive strength of the concrete forming compositions produced according to Examples 6 to 10 and Comparative Examples 3 and 4 are shown in Table 6 and FIG. 2 below.

TABLE 6

| | | Compressive strength |
|---|---|---|
| Classification | Ca/Si molar ratio | (MPa) |
| Control | — | 1.3 |
| Comparative Example 3 | 1.0 | 2.5 |
| Example 6 | 2.0 | 3.7 |
| Example 7 | 4.0 | 4.4 |
| Example 8 | 6.0 | 4.9 |
| Example 9 | 8.0 | 5.3 |
| Example 10 | 10.0 | 5.1 |
| Comparative Example 4 | 11.0 | 2.3 |

Referring to Tables 5 and 6 and FIG. 2, it was confirmed that the concrete produced by adding the nanoparticle for early strength development of concrete according to the present invention had more excellent compressive strength than the concrete (Control) to which the nanoparticle was not added. This is considered to be the result obtained when the nanoparticle accelerates early strength development of concrete. In addition, the nanoparticle for early strength development of concrete according to the present invention is characterized in that the molar ratio (Ca/Si) of calcium to silicon of the calcium silicate hydrate ranges from 2 to 10. It was confirmed that the compressive strength of Examples 1 to 10 with the Ca/Si molar ratio of 2.0, 4.0, 6.0, 8.0, and 10.0 was remarkably excellent, compared to Comparative Examples 1 and 3 (Ca/Si molar ratio: 1.0), which were the lower limit of 2 to 10 and Comparative Examples 2 and 4 (Ca/Si molar ratio: 11.0), which were the upper limit of 2 to 10. Therefore, it can be said that the numerical range in which the molar ratio (Ca/Si) of calcium to silicon in the nanoparticle for early strength development of concrete according to the present invention is 2 to 10 has critical significance.

It was confirmed through the concrete performance evaluation that the nanoparticle for early strength development of concrete according to the present invention could be used as an admixture for early strength development of concrete. Furthermore, early strength can be realized by using the nanoparticle as the admixture, and the effect of shortening the construction period and reducing the construction cost can be provided.

The present invention has been described in detail with reference to the preferred embodiments and the drawings, but the scope of the technical idea of the present invention is not limited to these drawings and embodiments. Accordingly, various modifications or equivalents thereof may fall within the scope of the technical idea of the present invention. Therefore, the scope of the technical idea according to the present invention should be interpreted by the claims, and the technical idea within the equivalents should be interpreted as falling within the scope of the present invention.

### INDUSTRIAL APPLICABILITY

A nanoparticle for early strength development of concrete according to the present invention can accelerate early strength development of concrete, and thus can be used as an early strength development accelerator, and has an effect of shortening the construction period and reducing the construction costs. Therefore, the nanoparticle according to the present invention is industrially applicable.

1. A nanoparticle for early strength development of concrete, the nanoparticle comprising calcium silicate hydrate,
wherein a molar ratio (Ca/Si) of calcium to silicon of the calcium silicate hydrate is 2 to 10.

2. The nanoparticle of claim 1, wherein a size of the nanoparticle is 10 nm to 1,000 nm.

3. A concrete forming composition comprising:
aggregate;
a binder;
an admixture; and
water,
wherein the admixture comprises the nanoparticle for early strength development of concrete according to claim 1.

4. The nanoparticle of claim 3, wherein the binder includes at least one selected from the group consisting of ordinary Portland cement, early strength Portland cement, lime cement, slag cement, blast furnace slag cement, slag powder, Portland pozzolan cement, fly ash, bottom ash, gypsum cement, lime cement, silica fume, low heat cement, and desulfurization gypsum.

5. A method for producing a nanoparticle for early strength development of concrete, the method comprising:
preparing a mixture by mixing a first solution containing a water-soluble calcium compound and a second solution containing a water-soluble silicate compound; and
stirring the mixture to produce a nanoparticle,
wherein the nanoparticle includes calcium silicate hydrate, and
a molar ratio (Ca/Si) of calcium to silicon of the calcium silicate hydrate is 2 to 10.

6. The method of claim 5, wherein the water-soluble calcium compound includes at least one selected from the group consisting of calcium nitrate, calcium chloride, calcium formate, calcium acetate, calcium bicarbonate, calcium bromide, calcium carbonate, calcium citrate, calcium chlolate, calcium fluoride, calcium gluconate, calcium hydroxide, calcium oxide, calcium hypochlorite, calcium iodate, calcium iodide, calcium lactate, calcium nitrite, calcium oxalate, calcium phosphate, calcium propionate, calcium silicate, calcium stearate, calcium sulfate, calcium sulfate hemihydrate, calcium sulfate dihydrate, calcium sulfide, calcium tartrate, calcium aluminate, tricalcium silicate, dicalcium silicate, and any hydrate thereof.

7. The method of claim 5, wherein the water-soluble silicate compound includes at least one selected from the group consisting of sodium silicate, potassium silicate, waterglass, aluminum silicate, tricalcium silicate, dicalcium silicate, calcium silicate, silicic acid, sodium metasilicate, potassium metasilicate, and any hydrate thereof.

8. The method of claim 5, wherein the nanoparticle is produced by a co-precipitation process.

9. The method of claim 5, wherein the mixture further includes at least one selected from the group consisting of a dispersant, an alkali metal hydroxide, and any combination thereof.

10. The method of claim 9, wherein the dispersant includes a polycarboxylate-based compound.

11. The method of claim 9, wherein the alkali metal hydroxide includes at least one selected from the group consisting of sodium hydroxide (NaOH), potassium hydroxide (KOH), and lithium hydroxide (LiOH).

12. The method of claim 5, further comprising, after the step of producing the nanoparticle, drying the nanoparticle.
